(19) United States
(12) Patent Application Publication
(10) Pub. No.: US 2016/0072776 A1
(43) Pub. Date: Mar. 10, 2016

(54) METHOD AND SYSTEM FOR EXCHANGING ENCRYPTED MESSAGES BETWEEN COMPUTING DEVICES IN A COMMUNICATION NETWORK

(71) Applicant: TREEBOX SOLUTIONS PTE LTD, Singapore (SG)

(72) Inventors: Ngai Kain YIP, Singapore (SG); Hon Tat LAU, Singapore (SG); Chee Wah CHONG, Singapore (SG); Li Huang NG, Singapore (SG); Wendy Siew Yen CHAN, Singapore (SG)

(73) Assignee: TreeBox Solutions Pte Ltd, Singapore (SG)

(21) Appl. No.: 14/786,514

(22) PCT Filed: Apr. 23, 2014
(86) PCT No.: PCT/SG2014/000180

§ 371 Date: Oct. 22, 2015

(30) Foreign Application Priority Data
Apr. 25, 2013 (SG) 201303261-0

(51) Int. Cl. H04L 29/06; G06F 21/60; H04L 12/58

(52) U.S. Cl. CPC H04L 63/0428; H04L 51/10; G06F 21/606

(57) ABSTRACT

A method for exchanging a message (202) between computing devices in a communication network, the message having encrypted data and a scheme identifier, is disclosed. The method comprises, in response to a first user action being performed on a first computing device (204), executing an encryption program code for encrypting data, encoding the encrypted data into the message and transmitting the message by the first computing device to a second computing device (206); detecting performance of a second user action on the second computing device in relation to the message; in response to detecting performance of the second user action, activating a decryption program code associated with the scheme identifier by the second computing device to provide the message to the decryption program code; decoding the message using the decryption program code by the second computing device to obtain the encrypted data; and decrypting the encrypted data by the second computing device via the decryption program code to obtain decrypted data. A related system is also disclosed.

### FIELD & BACKGROUND

The present invention relates to a method and system for exchanging a message, having encrypted data and a scheme identifier, between computing devices in a communication network.

Certain mobile operating systems (e.g. iOS™ from Apple Inc™) conventionally do not allow third-party developers' applications to intercept emails, SMS messages or the like as received. As a result, mobile applications developed by third-party developers, for use in those mobile operating systems, cannot be programmed to directly intercept those received emails or SMS messages. Consequently, for example, a third-party (developed) decryption application cannot be configured to automatically intercept and decrypt encrypted data received via an email or an SMS message. Instead, the received encrypted data is displayed as a body of static text in the user interface (UI) of the mobile operating system (i.e. see screenshot 100 of FIG. 1a), which does not easily facilitate further processing of the encrypted data by a user of any of the aforementioned mobile operating systems, as will be appreciated.

On those aforementioned mobile operating systems, a process of decrypting encrypted data, received via (e.g.) an email or an SMS message, typically requires the user to select and manually effect (digital) copying of the encrypted data to a working memory buffer of the mobile operating system (i.e. see screenshot 150 of FIG. 1b), and then manually effect (digital) pasting of the copied encrypted data (for feeding as data-stream) into the third-party decryption application, before finally manually effecting another user action (e.g. clicking an associated button) to activate the third-party decryption application to decrypt the encrypted data and thereafter display the decrypted result to the user. Indeed, the said process is complex, error-prone and also not user-friendly, as will be appreciated.

One object of the present invention is therefore to address at least one of the problems of the prior art and/or to provide a choice that is useful in the art.

### SUMMARY

According to a 1^{st} aspect of the invention, there is provided a method performed by a computing device for processing a message from another computing device in a communication network, the message including encrypted data and a scheme identifier. The method comprises detecting performance of a user action in relation to the message; in response to detecting performance of the user action, activating a decryption program code associated with the scheme identifier to provide the message to the program code; decoding the message using the program code to obtain the encrypted data; and decrypting the encrypted data via the program code to obtain decrypted data.

The method advantageously enables processing of the message (with encrypted data), received through a third-party digital messaging application, to be conveniently performed by automatically activating the decryption program code upon performance of the user action on the message, based on the scheme identifier, without requiring a user to manually copy-and-paste the message from the third-party digital messaging application to the decryption program code for processing to obtain the encrypted data. This proposed method thus reduces a number of user interactions required for processing such messages, and hence beneficially streamlines the overall user experience for performing such a task.

Preferably, the method may further comprise displaying the decrypted data to a user of the computing device. Specifically, the scheme identifier may include a header of the message. On the other hand, the message may further include at least a domain identifier, a session identifier and a data field, wherein the data field comprises the encrypted data.

Preferably, decoding the message to obtain the encrypted data may include performing the said decoding according to a predetermined decoding scheme, which includes a custom URL scheme. The decrypted data may include text, images, animation, video or audio. More preferably, the method may further comprise receiving the message via at least an SMS, an MMS, an email, instant messaging, or an electronic document delivery service. Also, the user action may include only a single action. The user action may include clicking a button, providing an audible instruction, or selecting the message. Yet preferably, the method may further comprise displaying an indication of a type of the user action to be performed.

According to a 2^{nd} aspect of the invention, there is provided a method performed by a computing device for providing a message having encrypted data to another computing device in a communication network. The method comprises, in response to a user action being performed, executing an encryption program code for encrypting data, encoding the encrypted data into the message and transmitting the message to the another computing device. The message includes a scheme identifier to enable the another computing device to activate a decryption program code associated with the scheme identifier for processing the message.

Preferably, the scheme identifier may include a header of the message. The method may further comprise receiving or generating data to be encrypted. The message may further include at least a domain identifier, a session identifier and a data field, wherein the encrypted data is provided in the data field.

Further preferably, encoding the encrypted data into the message may include performing the said encoding according to a predetermined encoding scheme, which includes a custom URL scheme. In addition, the method may further comprise displaying an indication of a type of the user action to be performed. The data may include text, images, animation, video or audio. Preferably, transmitting the message may include transmitting via at least an SMS, an MMS, an email, instant messaging, or an electronic document delivery service. Specifically, the user action may include only a single action, and also the user action may include clicking a button, providing an audible instruction, or selecting the received data. The method may preferably further comprise displaying a user interface for enabling selection or provision of the data to be encrypted.

According to a 3^{rd} aspect of the invention, there is provided a method performed by a mobile computing device for processing a message from another mobile computing device in a communication network, the message including encrypted data and a scheme identifier. The method comprises detecting performance of only a single action in relation to the message, in response to detecting performance of the single action, activating a decryption program code associated with the scheme identifier to provide the message to the program code, decoding the message using the program code to obtain the encrypted data, and decrypting the encrypted data via the program code to obtain decrypted data.

According to a 4^{th} aspect of the invention, there is provided a method performed by a mobile computing device for providing a message having encrypted data to another mobile computing device in a communication network. The method comprises in response to only a single action being performed, executing an encryption program code for encrypting data, encoding the encrypted data into the message and transmitting the message to the another mobile computing device. The message includes a scheme identifier to enable the another mobile computing device to activate a decryption program code associated with the scheme identifier for processing the message.

According to a 5^{th} aspect of the invention, there is provided a decryption device for processing a message from a computing device in a communication network, the message including encrypted data and a scheme identifier. The decryption device comprises a detector module for detecting performance of a user action in relation to the message, a processor module for receiving a detection signal from the detector module, and for activating a decryption program code associated with the scheme identifier to provide the message to the program code in response to the detection signal, a decoder module for decoding the message using the program code to obtain the encrypted data, and a decryption module for decrypting the encrypted data via the program code to obtain decrypted data.

Preferably, the device may yet also further comprise a display module for displaying the decrypted data to a user of the decryption device, or for displaying an indication of a type of the user action to be performed. Additionally, the scheme identifier may include a header of the message. The message may further include at least a domain identifier, a session identifier and a data field, wherein the data field comprises the encrypted data.

More preferably, the decoder module may be arranged to decode the message according to a predetermined decoding scheme, which includes a custom URL scheme. The decrypted data may include text, images, animation, video or audio. Also, the device may further comprise a receiver module for receiving the message via at least an SMS, an MMS, an email, instant messaging, or an electronic document delivery service. Moreover, the user action may include only a single action. And the user action may also include clicking a button, providing an audible instruction, or selecting the message.

According to a 6^{th} aspect of the invention, there is provided an encryption device configured to execute an encryption program code for providing a message having encrypted data to a computing device in a communication network. The encryption device comprises a processor module configured to response to a user action for executing an encryption program code for encrypting data, encoding the encrypted data into the message and transmitting the message to the computing device. The message includes a scheme identifier to enable the computing device to activate a decryption program code associated with the scheme identifier for processing the message.

Preferably, the scheme identifier may include a header of the message. The device may further comprise a receiver module for receiving data to be encrypted. Furthermore, the message may further include at least a domain identifier, a session identifier and a data field, wherein the encrypted data is provided in the data field.

Preferably, the processor module may be arranged to encode the encrypted data according to a predetermined encoding scheme, which includes a custom URL scheme. The device may also further comprise a display module for displaying an indication of a type of the user action to be performed. The data may include text, images, animation, video or audio. Also, the processor module may be configured to transmit the message using a transmitter module via at least an SMS, an MMS, an email, instant messaging, or an electronic document delivery service. Preferably, the user action may include only a single action, or the user action may include clicking a button, providing an audible instruction, or selecting the received data. More preferably, the device may further comprise a user interface module for displaying a user interface for enabling selection or provision of the data to be encrypted.

According to a 7^{th} aspect of the invention, there is provided a method for exchanging a message between computing devices in a communication network, the message having encrypted data and a scheme identifier. The method comprises in response to a first user action being performed on a first computing device, executing an encryption program code for encrypting data, encoding the encrypted data into the message and transmitting the message by the first computing device to a second computing device, detecting performance of a second user action on the second computing device in relation to the message, in response to detecting performance of the second user action, activating a decryption program code associated with the scheme identifier by the second computing device to provide the message to the decryption program code, decoding the message using the decryption program code by the second computing device to obtain the encrypted data, and decrypting the encrypted data by the second computing device via the decryption program code to obtain decrypted data.

According to an 8^{th} aspect of the invention, there is provided a system for exchanging a message between computing devices in a communication network, the message having encrypted data and a scheme identifier. The system comprises a first computing device comprising a processor module configured to response to a first user action for executing an encryption program code for encrypting data, encoding the encrypted data into the message and transmitting the message to the second computing device, and a second computing device comprising a detector module for detecting performance of a second user action in relation to the message, a processor module for receiving a detection signal from the detector module, and for activating a decryption program code associated with the scheme identifier to provide the message to the decryption program code in response to the detection signal, a decoder module for decoding the message using the decryption program code to obtain the encrypted data, and a decryption module for decrypting the encrypted data via the decryption program code to obtain decrypted data.

It should be apparent that features relating to one aspect of the invention may also be applicable to the other aspects of the invention.

These and other aspects of the invention will be apparent from and elucidated with reference to the embodiments described hereinafter.

### BRIEF DESCRIPTION OF THE DRAWINGS

Embodiments of the invention are disclosed hereinafter with reference to the accompanying drawings, in which:

FIG. 1a is a screenshot showing encrypted data in an SMS message received by a mobile operating system, in which the encrypted data is displayed as static text on the mobile operating system, according to the prior art;

FIG. 1b is a screenshot, following from FIG. 1a, whereby a user of the mobile operating system effects a “copying” action to digitally copy the encrypted data to a working memory buffer of the said mobile operating system;

FIG. 2 is a schematic diagram depicting a system for exchanging a message, having encrypted data, between first and second computing devices in a communication network, according to an embodiment of the present invention;

FIG. 3 is a flow diagram of a method for providing the message by the first computing device to the second computing device of FIG. 2;

FIG. 4a is a flow diagram of a process for encrypting and encoding data, as used in the method in FIG. 3;

FIG. 4b is a flow diagram of a process for transmitting the message, as used in the method in FIG. 3;

FIG. 5 is a flow diagram of a method for processing the message received by the second computing device from the first computing device of FIG. 2;

FIG. 6a is a screenshot showing receipt of the message by the second computing device of FIG. 2;

FIG. 6b is a flow diagram of a process for decoding and decrypting the message, as used in the method in FIG. 5; and

FIG. 7 is a flow diagram of a process for transmitting the message, as used in the method in FIG. 3, according to another embodiment.

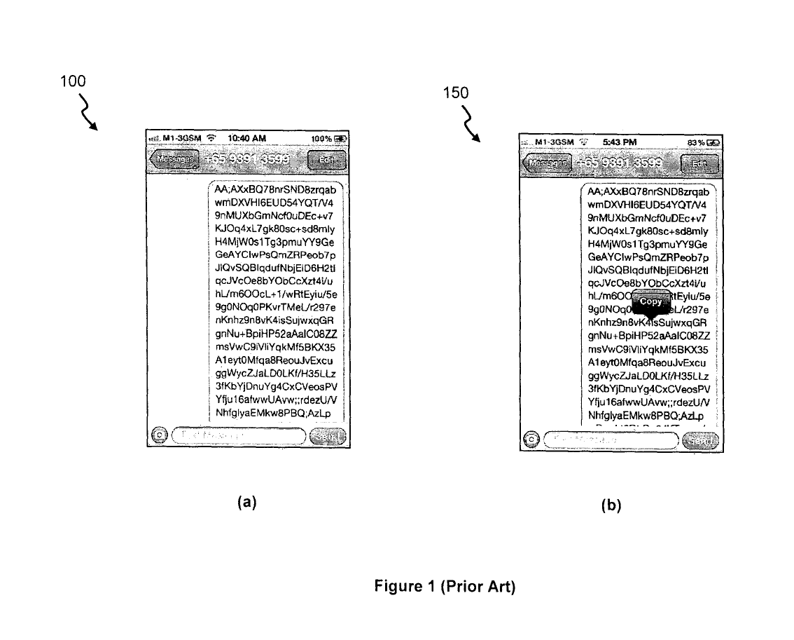

### DETAILED DESCRIPTION OF PREFERRED EMBODIMENTS

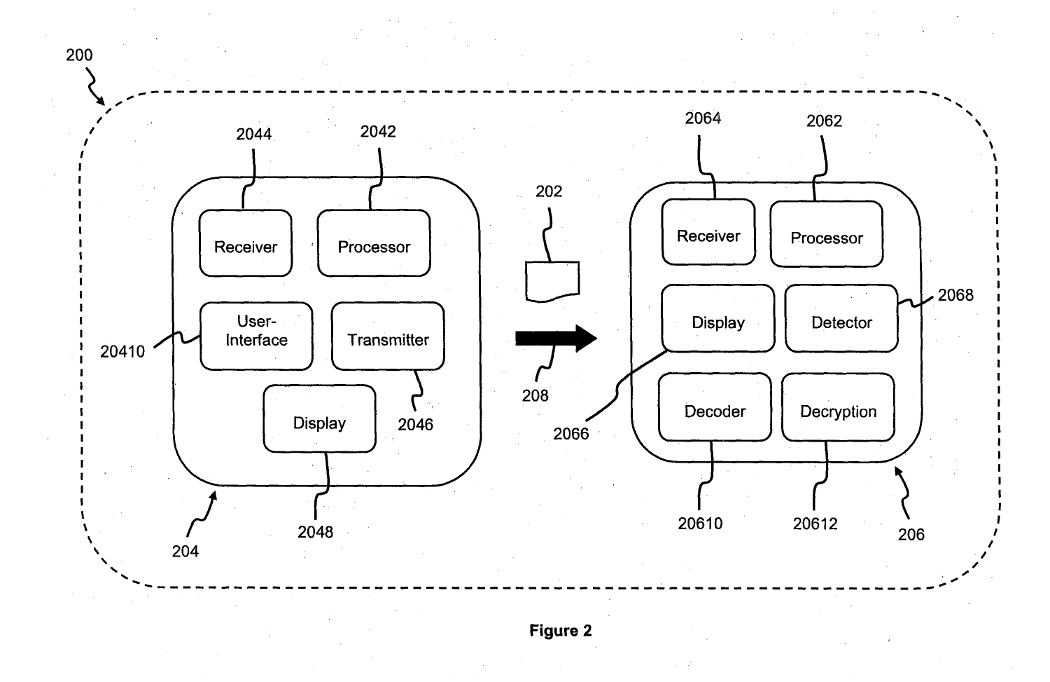

A system 200 (i.e. see a schematic diagram in FIG. 2) and corresponding method for exchanging a message 202, having encrypted data, between computing devices (which include first and second computing devices 204, 206) in a communication network is disclosed, according to a first embodiment. Examples of the first and second computing devices 204, 206 include mobile computing devices (e.g. smartphones like iPhone™ or tablets like iPad™), wired computers (e.g. desktop personal computers) or the like. However, for the purpose of this embodiment, the first and second computing devices 204, 206 are mobile computing devices running on a predetermined suitable mobile operating system (e.g. iOS™ from Apple Inc™). For ease of referencing hereinafter, the first and second computing devices 204, 206 are respectively referred to as the encryption device 204 and the decryption device 206, unless otherwise explicitly stated. It will also be appreciated that there can be multiple encryption devices 204 and decryption devices 206 arranged within the communication network to exchange messages 202, having corresponding encrypted data, with one another, but not specifically shown in FIG. 2 in this instance, for sake of brevity.

The encryption device 204 is configured to execute an encryption program code for providing the message 202 to the decryption device 206, whereas the decryption device 206 is configured to execute a decryption program code for processing the message 202 from the encryption device 204. It will be appreciated that, in this embodiment, the encryption and decryption program codes are locally installed on the encryption device and decryption device 204, 206, and further, the encryption and decryption program codes are realised as native mobile applications. Specifically, the encryption device 204 includes the following modules: a processor module 2042, a receiver module 2044, a transmitter module 2046, a display module 2048, and a user interface module 20410. On the other hand, the decryption device 206 includes the following modules: a processor module 2062, a receiver module 2064, a display module 2066, a detector module 2068, a decoder module 20610, and a decryption module 20612. In this instance, it is to be understood that the respective said modules of the encryption device 204 and decryption device 206 are implemented in software.

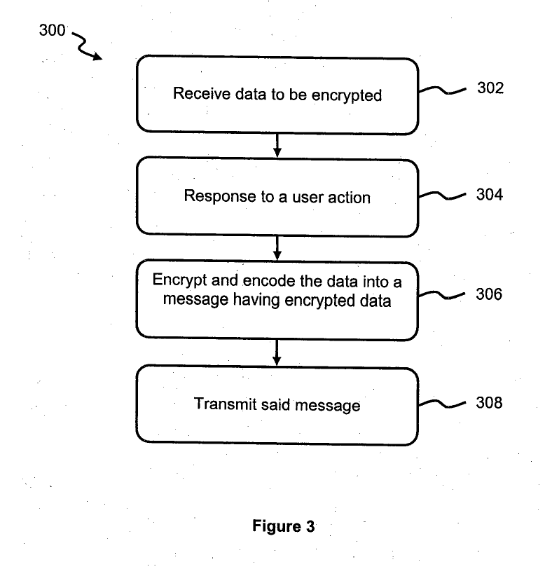

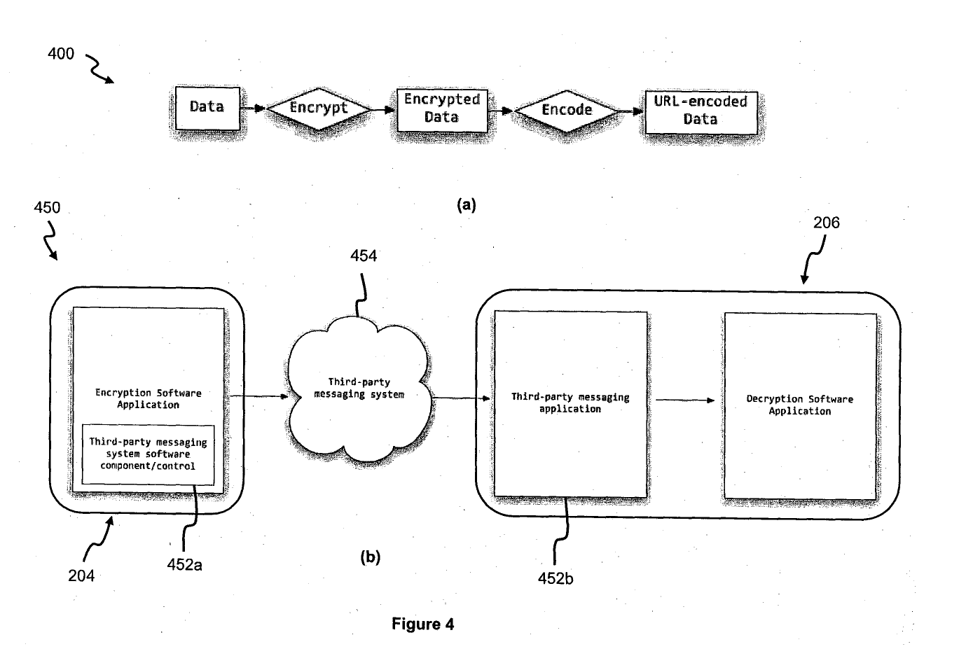

Reference is now made to FIGS. 3 and 4 to describe a method 300 performed by the encryption device 204 for providing the message 202 to the decryption device 206. The method 300 begins at Step 302 where the receiver module 2044 receives data to be encrypted, which involves the user interface module 20410 presenting an interface to a user (not shown) of the encryption device 204 for providing or selecting the data (from a data store of the encryption device 204) to be encrypted and also for the user to select a recipient (i.e. the decryption device 206 in this instance) from a recipient list to send the message 202 to. It will be appreciated that the data includes text, images, animation, video or audio. Further, an indication of a type of a user action that is to be performed on the encryption device 204 for subsequently causing encrypting, encoding, and sending the data is also displayed to the user on the encryption device 204 by the display module 2048. Examples of the user action include clicking a button (e.g. using a mouse or a finger of the user), providing an audible instruction, selecting (e.g. by highlighting) the received data or the like. It is also highlighted that in this embodiment, the user action involves performing only a single action, such as a single tapping of a button.

Once the user has selected or provided the data to be encrypted, the user then performs the indicated user action, which consequently, at Step 304 causes the processor module 2042 to response to the user action by executing the encryption program code. More specifically, thereafter at Step 306, in response to the user action being performed, the processor module 2042, by using the encryption program code, encrypts the data, and encodes the encrypted data into the message 202 carrying the encrypted data. It is to be appreciated that the message 202 is of a specific encoded format. In connection, FIG. 4a shows a flow diagram of a process 400 performed by the processor module 2042 for encrypting and encoding the data. Particularly, the process 400 of FIG. 4a involves first encrypting the data to obtain the encrypted data, which is then encoded according to a predetermined encoding scheme to obtain the message 202 with the specific encoded format. The predetermined encoding scheme, which is configured to be a custom URL scheme in this instance, specifically encodes the encrypted data into the message 202 having a corresponding custom uniform resource locator (URL) format, which includes at least the following fields: a scheme identifier, a domain identifier, a session identifier and a data field. It will be appreciated that the domain identifier can be used, for example, to encode un-encrypted information transmitted by the encryption device 204 to the decryption device 206. On the other hand, it will also be appreciated that the scheme identifier is defined for a purpose to enable processing of the message 202 by the decryption device 206 upon receipt thereof.

Particularly, the decryption program code is configured to be registered to use an “inter-application communications via custom URL scheme” of the mobile operating system of the decryption device 206 to facilitate handling and processing of any messages 202, as transmitted by the encryption device 204, determined to have a same data definition of the scheme identifier. That is, the decryption program code is associated with the scheme identifier, as defined by the encryption device 204 in the message 202. A custom URL is an URL specially formatted to comprise different customised identifier fields. This “inter-application communications via custom URL scheme” will be elaborated in subsequent paragraphs. In addition, the encrypted data is provided in the data field, as will be appreciated. The custom URL format is defined with the following syntax:

[A]://[B]?id=[C]&[D] (1)

wherein “[A]” represents the header identifier, “[B]” represents the domain identifier, “[C]” represents the session identifier, and “[D]” represents the data field. To illustrate, an example of the message 202 as defined in accordance with syntax (1) as a custom URL, in which “ontalk” is defined in “[A]”, “com.treeboxsolutions.ontalk.sso” is defined in “[B]”, a random ID of “AAAA” is defined in “[C]”, and the encrypted data of “XXXX”, to be transmitted to the decryption device 206 via SMS, is defined in “[D]” as “sms=XXXX”, will be:

ontalk://com.treeboxsolutions.ontalk.sso?id=AAAA&sms=XXXX (2)

Thus, the encryption device 204 transmits the message 202, for example with the predetermined identifier of “ontalk”, which will also be recognised by the decryption device 206 (as above mentioned) for processing purposes. Of course, it will also be understood that if the encrypted data of “XXXX” is to be transmitted instead using other communication means, for example such as MMS or email, then “[D]” in syntax (1) will be defined as “mms=XXXX” or “email=XXXX” accordingly (or the like).

Then at Step 308, under the command of the processor module 2042, the transmitter module 2046 transmits the message 202 to the decryption device 206 as indicated by an arrow 208 (pointing in a direction from the encryption device 204 to the decryption device 206) shown in FIG. 2. The message 202 is transmitted via, for example, an SMS, an MMS, an email, instant messaging, an electronic document delivery service or the like. It is to be appreciated that Steps 306 and 308 are executed in sequence, but collectively as a whole, in response to the user action performed by the user of the encryption device 204. With reference also to FIG. 4b, which shows a flow diagram of a process 450 performed by the transmitter module 2046 for transmitting the message 202, the message 202 is transmitted by way of a third-party messaging software component 452a, which is specifically adopted to interface with the transmitter module 2046. In this instance, the transmitter module 2046 is integrated with the third-party messaging software component 452a, specifically by interfacing with relevant APIs provided by the third-party messaging software component 452a.

Particularly, this process 450 of FIG. 4b involves first sending the message 202 by the encryption device 204, through the third-party messaging software component 452a, to a third party messaging system 454, which in turn forwards the message 202 to a similar third-party messaging software component 452b arranged at the decryption device 206. In this case, the third-party messaging software component 452b arranged at the decryption device 206 is provided in the mobile operating system as a separate application, as shown in FIG. 4b, and is a program code different from the decryption program code. It will be understood that the third party messaging system 454 is provided within the communication network but functions independently of the encryption device 204 and decryption device 206, although arranged to be in data communication with both the encryption device 204 and decryption device 206. It is also to be mentioned that the third party messaging system 454 is included as part of the system 200 of FIG. 2.

Before discussing the “inter-application communications via custom URL scheme”, it would be appropriate to first explain custom URL schemes. It will be understood that a URL, also known as web address, is a specific character string that constitutes a reference to a resource. In web browsers, the URL of a web page is displayed in an address bar, typically located at the top section of the web page. An example of a typical URL would be “http://en.example.org/wiki/Main_Page”. Every URL is typically defined to be in the following format: a scheme name (or commonly called protocol), followed by a colon, two slashes, then, depending on the scheme, a server name (e.g. “exp.” “ftp.”, “www.”, “smtp.” etc) followed by a dot (“.”) then a domain name (or alternatively, an IP address), a port number, the path of the resource to be fetched or the program to be run, and then, for programs such as Common Gateway Interface (CGI) scripts, a query string, and an optional fragment identifier. In summary, the syntax is of a URL is generally defined as:

scheme://domain:port/path?query_string#fragment_id (3)

Now then, a custom URL scheme is a mechanism through which third-party mobile applications installed on a same mobile device are able to communicate with one another via corresponding specially formatted URLs. Mobile applications can use custom URL schemes to vend services to other mobile applications, as desired. Specifically, custom mobile applications can receive specially formatted URLs by registering corresponding custom URL schemes with the mobile operating system, which then binds those mobile applications to the said custom URL schemes. It is to be appreciated that in the case of the mobile operating system being, for example, iOS version 6.0 and lower, the mobile operating system recognizes the specially formatted URLs based on just the scheme identifier. In the case of the mobile operating system being, for example, Android™ OS, it can then additionally include the domain identifier such that the mobile operating system can associate the specially formatted URLs with a specific mobile application based on both the scheme and domain identifiers.

With regard to the “inter-application communications via custom URL scheme”, it will be appreciated that some mobile operating systems (e.g. e.g. iOS™ from Apple Inc™) specifically include support for the specific said scheme, in which native mobile applications (installed on a mobile computing device) configured to register with the mobile operating systems for binding with the said scheme can then advantageously utilise the scheme to exchange messages between other different mobile applications installed on the same device running the associated mobile operating system. The messages to be exchanged are specified in custom URLs that are passed between the different mobile applications, as required. Registered mobile applications can use the custom URL scheme to initiate specific requests. For example, if it is desired for a registered mobile application to display an address in a Maps application, the registered mobile application can create a custom URL, specifying the address to be displayed, and thereafter make use of the created custom URL to invoke launch of the Maps application (by the mobile operating system). Once launched, the created custom URL is automatically passed from the registered mobile application to the Maps application, which then reads and displays the specified address accordingly. It will be appreciated that different custom-developed mobile applications can implement different custom URL schemes that can create corresponding specially formatted custom URLs (as desired based on needs of associated areas of applications) to facilitate similar types of communications.

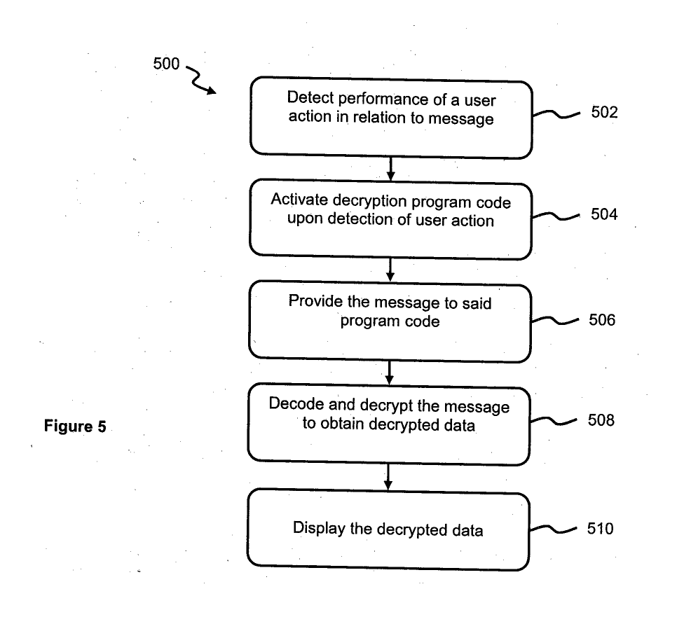

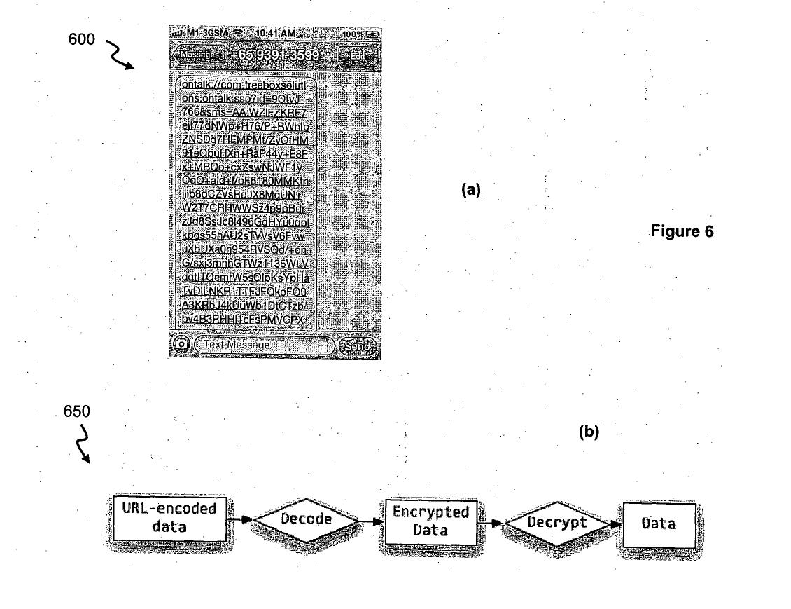

Reference is now made to FIGS. 5 and 6 to describe a method 500 performed by the decryption device 206 for processing the message 202 from the encryption device 204. In particular, FIG. 6a is a screenshot 600 showing receipt of the message 202 by the decryption device 206 via the third-party messaging software component 452b. It will be appreciated that the message 202 is received by the receiver module 2064 of the decryption device 206 through the third-party messaging software component 452b at the decryption device 206 as, for example, an SMS, an MMS, an email, or via instant messaging, an electronic document delivery service or the like. The third-party messaging software component 452b at the decryption device 206 then displays the message 202, together with an indication of a type of a user action that is to be performed by a user (not shown) of the decryption device 206 for processing the message 202. The definition of the user action in this instance is the same as that afore described in the method 300 of FIG. 3, but to be read in the context of the message 202 as received (and not the data to be encrypted), and hence will not be repeated for brevity.

The message 202, for example if received via an SMS, is highlighted and underlined as blue-coloured text by the third-party messaging software component 452b, and digitally selectable by the user of the decryption device 206 through performing the indicated user action. It is to be understood that the underlining of the message 202 as blue-coloured text is given as a non-limiting example and other suitable forms of highlighting or indication are also possible as would be understood by skilled persons. For example, the highlighting can also be displayed in the form of an icon in the message 202. Subsequently, the user of the decryption device 206 can then select the message 202 by performing the indicated user action (e.g. tapping on the blue-coloured text). At Step 502 of the method 500 of FIG. 5, the detector module 2068 of the decryption device 206 detects performance of the user action performance in relation to the message 202. As previously described, the message 202 is in fact a specially formatted URL generated based on the custom URL scheme, and thus performance of the indicated user action causes (the mobile operating system of) the decryption device 206 to automatically activate (e.g. launch) the decryption program code at Step 504 of the method 500, the activation being effected based on the scheme identifier determined from the message 202. As previously mentioned, the decryption program code is associated with the scheme identifier. The message 202 is then provided, verbatim, by the third-party messaging software component 452b to the decryption program code via the custom URL scheme for further processing at Step 506 of this same method being described.

Subsequently, the decoder module 20610, at Step 508, decodes the message 202, using the decryption program code, to obtain the encrypted data, and thereafter the decryption module 20612 decrypts the encrypted data, also using the decryption program code, to obtain decrypted data. In connection, FIG. 6b shows a flow diagram of a process 650 performed by the decoder module 20610 and decryption module 20612 of the decryption device 206 for respectively decoding and decrypting the message 202. Particularly, the process 650 of FIG. 6b involves first decoding the message 202 according to a predetermined decoding scheme to obtain the encrypted data, which is then decrypted to obtain the decrypted data. It will be appreciated that the predetermined decoding scheme is simply executed in reverse sequence to the predetermined encoding scheme (as used in the process 400 of FIG. 4a). It is also to be appreciated that Steps 506 and 508 are executed in sequence, but collectively as a whole, in response to the user action of the user of the decryption device 206. In addition, Steps 504 to 508 are also executed in response to detection of performance of the user action by the detector module 2068. Then, at Step 510, the display module 2066 displays the decrypted data to the user of the decryption device 206.

Further embodiments of the invention will be described hereinafter. For the sake of brevity, description of like elements, functionalities and operations that are common between the embodiments are not repeated; reference will instead be made to similar parts of the relevant embodiment(s).

According to a second embodiment, the respective modules of the encryption device 204 and decryption device 206 are hardware-based, rather than software-based. Indeed, in this instance, the processor module 2042, the receiver module 2044, the transmitter module 2046, the display module 2048, and the user interface module 20410 of the encryption device 204 are implemented in hardware for faster response time and more efficient processing of the message 202. Likewise, the processor module 2062, the receiver module 2064, the display module 2066, the detector module 2068, the decoder module 20610, and the decryption module 20612 of the decryption device 206 are also implemented in hardware to achieve the same aforementioned advantages in respect of processing the message 202.

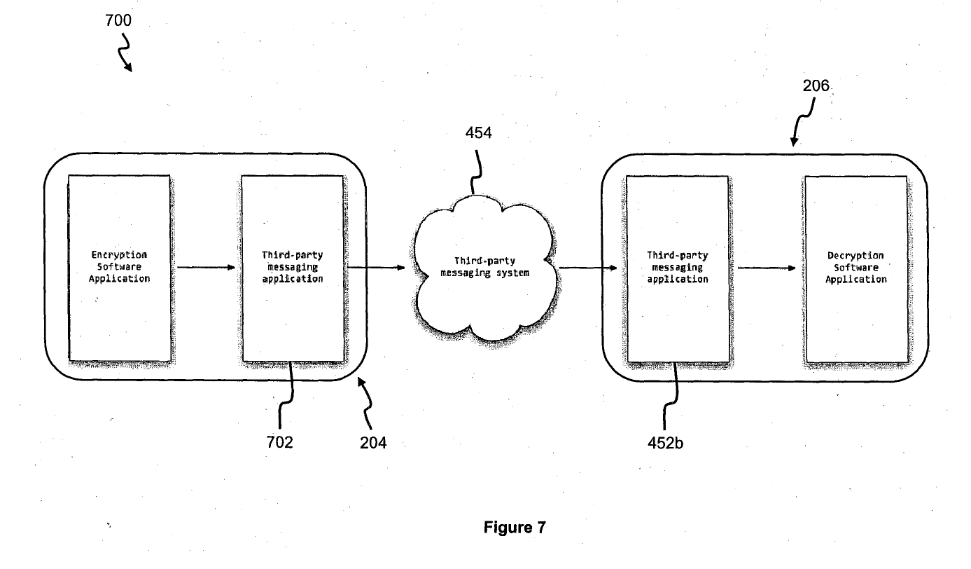

According to a third embodiment, with reference to FIG. 7 which depicts a flow diagram of another process 700 performed by the transmitter module 2046 for transmitting the message 202, the message 202 is transmitted by way of another third-party messaging software component 702, different from that 452a shown in FIG. 4. In this case, the third-party messaging software component 702 at the encryption device 204 is pre-provided and installed in the mobile operating system, and communication by the transmitter module 2046 (of the encryption device 204) with the third-party messaging software component 702 is effected using the “inter-application communications via custom URL scheme”. With reference also to the method 300 of FIG. 3, once the processor module 2042 encrypts the data, and encodes the encrypted data into the message 202, the message 202 is then communicated by the transmitter module 2046 (under command of the processor module 2042) to said third-party messaging software component 702 of FIG. 7 via a corresponding custom URL scheme. In this instance, the entire message 202 is inserted under “[D]” as per syntax (1) of a custom URL, defined in accordance with the corresponding custom URL scheme. It is however also to be appreciated that in other envisaged variations, the entire message 202 need not be inserted under “[D]”; instead it depends on the custom URL scheme as defined, since any information written after the delimiter “?”, as per syntax (1), is customisable. Upon receipt, the third-party messaging software component 702 extracts the message 202 from the associated custom URL as received, and subsequently transmits the message 202 to the third party messaging system 454 (as afore described in FIG. 4), which forwards the message 202 to the third-party messaging software component 452b arranged at the decryption device 206 for processing. From thereon, the rest of the process for decrypting the message 202 will be the same as that afore described in the first embodiment, and hence not repeated for brevity sake.

In summary, the proposed system 200 (and corresponding method) enables exchange of messages, having encrypted data, between the first and second computing devices 204, 206 in a communication network, and more specifically through utilisation of the “inter-application communications via custom URL scheme”. The encryption device 204 provides a user-interface for the input or selection of data to be encrypted and displays an indication of a type of a user action (e.g. tapping a button) that a user of the encryption device 204 is to perform for secure processing of the data into the message 202 carrying the encrypted data, and scheme identifier. Thereafter, in response to the indicated user action being performed, the data is encrypted and encoded into the message 202 by way of a custom URL format, and sent to the decryption device 206 via the third-party digital messaging system 454. The decryption program code on the decryption device 206 is registered with the mobile operating system installed thereon to handle processing of the message 202 via the custom URL scheme. That is, the decryption program code is associated with the scheme identifier. The third-party messaging software component 452b at the decryption device 206 receives and displays the message 202, and also displays an indication of a user action (e.g. selecting the highlighted display of the message 202) that a user of the decryption device 206 is to perform to decrypt the message 202. In response to the indicated user action being performed, the decryption program code is automatically activated by the mobile operating system (installed on the decryption device 206) and the message is then forwarded by the third-party messaging software component 452b to the decryption program code for processing to obtain the decrypted data. Subsequently, the decrypted data is displayed to the user of the decryption device 206.

Thus, by utilising the custom URL schemes in conjunction with inter-application communication support offered by the relevant mobile operating systems, the method 500 of FIG. 5 advantageously enables processing of the message 202 (with encrypted data), received through the third-party digital messaging application 452b, to be conveniently performed by automatically activating the decryption program code upon performance of the user action on the message 202, based on the scheme identifier, without a need to have to manually copy-and-paste the message from the third-party digital messaging application 452b to the decryption program code for processing to obtain the encrypted data, as is otherwise the case conventionally. This proposed method 500 thus reduces a number of user interactions required for processing such messages, and hence beneficially streamlines the overall user experience for performing such a task. It is to be appreciated that additional metadata/parameters about the encrypted message can be encoded in the custom URLs such as, for example, algorithm type, key length, etc, which advantageously enables automatic communication of those additional metadata/parameters to the decryption program code. Consequently this saves users the hassle of manually specifying those additional metadata/parameters via a user-interface through the copy-and-paste method, as performed conventionally.

The described embodiments should not however be construed as limitative. For example, it is to be appreciated that the first and second computing devices 204, 206 may be any other types of devices besides mobile computing devices, and the operating systems on which the first and second computing devices 204, 206 run on are to also include support for the “inter-application communications via custom URL scheme” (as afore described), or alternatively an equivalent scheme with similar functionality. Additionally, in certain embodiments, the respective modules of the encryption device 204 and decryption device 206 (if implemented in software) may be programmatically integrated and provided as a single complete software application that is installable on and executable by similar computing devices that may be envisaged for processing the messages 202. Of course, in such an instance, the encryption device 204 may send or receive messages 202 to or from the decryption device 206, and vice versa. Optionally, the single complete software application may be implemented in its entirety in hardware, and a copy of such an implemented hardware is installable on each of the encryption device 204 and the decryption device 206 for processing the messages 202.

It will also be understood that the user action, as indicated to be effected, may not necessary need to be only a single action; the user action can instead be a series of user actions, such as double tapping or double clicking (using a mouse) of highlighted text or the like. Further, in certain embodiments, the encryption device 204 may also, optionally, include a data generator module (not shown) that allows the user of the encryption device 204 to generate the desired data to be encrypted, instead of selecting or providing the data via the interface presented by the user interface module 20410. Additionally, other variations may include using the custom URLs to communicate non-sensitive metadata about the encrypted data, i.e. in a manner similar to how the header of an encrypted file format holds metadata about the file such as version, etc.

While the invention has been illustrated and described in detail in the drawings and foregoing description, such illustration and description are to be considered illustrative or exemplary, and not restrictive; the invention is not limited to the disclosed embodiments. Other variations to the disclosed embodiments can be understood and effected by those skilled in the art in practising the claimed invention.

1. A method performed by a computing device for processing a message from another computing device in a communication network, the message including encrypted data and a scheme identifier, the method comprises:
detecting performance of a user action in relation to the message;
in response to detecting performance of the user action, activating a decryption program code associated with the scheme identifier to provide the message to the program code;
decoding the message using the program code to obtain the encrypted data; and
decrypting the encrypted data via the program code to obtain decrypted data.

2. The method of claim 1, further comprises displaying the decrypted data to a user of the computing device.

3. The method of any preceding claims, wherein the scheme identifier includes a header of the message.

4. The method of any preceding claims, wherein the message further includes at least a domain identifier, a session identifier and a data field, wherein the data field comprises the encrypted data.

5. The method of any preceding claims, wherein decoding the message to obtain the encrypted data includes performing the said decoding according to a predetermined decoding scheme, which includes a custom URL scheme.

6. The method of claim 1, wherein the decrypted data includes text, images, animation, video or audio.

7. The method of any preceding claims, further comprises receiving the message via at least an SMS, an MMS, an email, instant messaging, or an electronic document delivery service.

8. The method of any preceding claims, wherein the user action includes only a single action.

9. The method of any preceding claims, wherein the user action includes clicking a button, providing an audible instruction, or selecting the message.

10. The method of any preceding claims, further comprises displaying an indication of a type of the user action to be performed.

11. A method performed by a computing device for providing a message having encrypted data to another computing device in a communication network, the method comprises:
in response to a user action being performed, executing an encryption program code for encrypting data, encoding the encrypted data into the message and transmitting the message to the another computing device,
wherein the message includes a scheme identifier to enable the another computing device to activate a decryption program code associated with the scheme identifier for processing the message.

12. The method of claim 11, wherein the scheme identifier includes a header of the message.

13. The method of claim 11 or 12, further comprises receiving or generating data to be encrypted.

14. The method of any of claims 11 to 13, wherein the message further includes at least a domain identifier, a session identifier and a data field, wherein the encrypted data is provided in the data field.

15. The method of any of claims 11 to 14, wherein encoding the encrypted data into the message includes performing the said encoding according to a predetermined encoding scheme, which includes a custom URL scheme.

16. The method of any of claims 11 to 15, further comprises displaying an indication of a type of the user action to be performed.

17. The method of any of claims 11 to 16, wherein the data includes text, images, animation, video or audio.

18. The method of any of claims 11 to 17, wherein transmitting the message includes transmitting via at least an SMS, an MMS, an email, instant messaging, or an electronic document delivery service.

19. The method of any of claims 11 to 18, wherein the user action includes only a single action.

20. The method of any of claims 11 to 19, wherein the user action includes clicking a button, providing an audible instruction, or selecting the received data.

21. The method of any of claims 11 to 20, further comprises displaying a user interface for enabling selection or provision of the data to be encrypted.

22. A method performed by a mobile computing device for processing a message from another mobile computing device in a communication network, the message including encrypted data and a scheme identifier, the method comprises:
detecting performance of only a single action in relation to the message;
in response to detecting performance of the single action, activating a decryption program code associated with the scheme identifier to provide the message to the program code;
decoding the message using the program code to obtain the encrypted data; and
decrypting the encrypted data via the program code to obtain decrypted data.

23. A method performed by a mobile computing device for providing a message having encrypted data to another mobile computing device in a communication network, the method comprises:
in response to only a single action being performed, executing an encryption program code for encrypting data, encoding the encrypted data into the message and transmitting the message to the another mobile computing device,
wherein the message includes a scheme identifier to enable the another mobile computing device to activate a decryption program code associated with the scheme identifier for processing the message.

24. A decryption device for processing a message from a computing device in a communication network, the message including encrypted data and a scheme identifier, the decryption device comprising:
a detector module for detecting performance of a user action in relation to the message;
a processor module for receiving a detection signal from the detector module, and for activating a decryption program code associated with the scheme identifier to provide the message to the program code in response to the detection signal;
a decoder module for decoding the message using the program code to obtain the encrypted data; and
a decryption module for decrypting the encrypted data via the program code to obtain decrypted data.

25. The device of claim 24, further comprising a display module for displaying the decrypted data to a user of the decryption device, or for displaying an indication of a type of the user action to be performed.

26. The device of any of claims 24 to 25, wherein the scheme identifier includes a header of the message.

27. The device of any of claims 24 to 26, wherein the message further includes at least a domain identifier, a session identifier and a data field, wherein the data field comprises the encrypted data.

28. The device of any of claims 24 to 27, wherein the decoder module is arranged to decode the message according to a predetermined decoding scheme, which includes a custom URL scheme.

29. The device of claim 24, wherein the decrypted data includes text, images, animation, video or audio.

30. The device of any of claims 24 to 29, further comprising a receiver module for receiving the message via at least an SMS, an MMS, an email, instant messaging, or an electronic document delivery service.

31. The device of any of claims 24 to 30, wherein the user action includes only a single action.

32. The device of any of claims 24 to 31, wherein the user action includes clicking a button, providing an audible instruction, or selecting the message.

33. An encryption device configured to execute an encryption program code for providing a message having encrypted data to a computing device in a communication network, the encryption device comprising:
a processor module configured to response to a user action for executing an encryption program code for encrypting data, encoding the encrypted data into the message and transmitting the message to the computing device,
wherein the message includes a scheme identifier to enable the computing device to activate a decryption program code associated with the scheme identifier for processing the message.

34. The device of claim 33, wherein the scheme identifier includes a header of the message.

35. The device of claim 33 or 34, further comprising a receiver module for receiving data to be encrypted.

36. The device of any of claims 33 to 35, wherein the message further includes at least a domain identifier, a session identifier and a data field, wherein the encrypted data is provided in the data field.

37. The device of any of claims 33 to 36, wherein the processor module is arranged to encode the encrypted data according to a predetermined encoding scheme, which includes a custom URL scheme.

38. The device of any of claims 33 to 37, further comprising a display module for displaying an indication of a type of the user action to be performed.

39. The device of any of claims 33 to 38, wherein the data includes text, images, animation, video or audio.

40. The device of any of claims 33 to 39, wherein the processor module is configured to transmit the message using a transmitter module via at least an SMS, an MMS, an email, instant messaging, or an electronic document delivery service.

41. The device of any of claims 33 to 40, wherein the user action includes only a single action.

42. The device of any of claims 33 to 41, wherein the user action includes clicking a button, providing an audible instruction, or selecting the received data.

43. The device of any of claims 33 to 42, further comprising a user interface module for displaying a user interface for enabling selection or provision of the data to be encrypted.

44. A method for exchanging a message between computing devices in a communication network, the message having encrypted data and a scheme identifier, the method comprises:
in response to a first user action being performed on a first computing device, executing an encryption program code for encrypting data, encoding the encrypted data into the message and transmitting the message by the first computing device to a second computing device;
detecting performance of a second user action on the second computing device in relation to the message;
in response to detecting performance of the second user action, activating a decryption program code associated with the scheme identifier by the second computing device to provide the message to the decryption program code;
decoding the message using the decryption program code by the second computing device to obtain the encrypted data; and
decrypting the encrypted data by the second computing device via the decryption program code to obtain decrypted data.

45. A system for exchanging a message between computing devices in a communication network, the message having encrypted data and a scheme identifier, the system comprising:
a first computing device comprising a processor module configured to response to a first user action for executing an encryption program code for encrypting data, encoding the encrypted data into the message and transmitting the message to the second computing device; and
a second computing device comprising:
a detector module for detecting performance of a second user action in relation to the message;
a processor module for receiving a detection signal from the detector module, and for activating a decryption program code associated with the scheme identifier to provide the message to the decryption program code in response to the detection signal;
a decoder module for decoding the message using the decryption program code to obtain the encrypted data; and
a decryption module for decrypting the encrypted data via the decryption program code to obtain decrypted data.
